(19) United States
(12) Patent Application Publication
(10) Pub. No.: US 2026/0321657 A1
(43) Pub. Date: Oct. 15, 2026

(54) POSITIVE ELECTRODE ACTIVE MATERIAL FOR LITHIUM SECONDARY BATTERY, POSITIVE ELECTRODE FOR LITHIUM SECONDARY BATTERY, LITHIUM SECONDARY BATTERY, AND METHOD FOR PRODUCING POSITIVE ELECTRODE ACTIVE MATERIAL FOR LITHIUM SECONDARY BATTERY

(71) Applicant: SUMITOMO METAL MINING Co., Ltd., Tokyo (JP)

(72) Inventors: Shingo TACHIBANA, Niihama-shi (JP); Ryo KURIKI, Niihama-shi (JP)

(21) Appl. No.: 19/147,820

(22) PCT Filed: Jun. 20, 2023
(86) PCT No.: PCT/JP2023/022772

§ 371 Date: Jul. 14, 2025

(30) Foreign Application Priority Data
Jun. 22, 2022 (JP) 2022-100002

(51) Int. Cl. H01M 4/62; H01M 4/02; H01M 4/36; H01M 4/525; H01M 10/0525

(52) U.S. Cl. CPC H01M 4/628; H01M 4/366; H01M 4/525; H01M 10/0525; H01M 2004/021

(57) ABSTRACT

A positive electrode active material for lithium secondary battery and the like, which can easily realize a lithium secondary battery having excellent rate performance while suppressing generation of gas, are provided. In the positive electrode active material for lithium secondary battery of the present invention, in a case where, in an adsorption isotherm of a water-vapor adsorption method, a water-vapor adsorption amount at a relative pressure p/p₀ of 0.5 is denoted as Va_{0.5} and a water-vapor adsorption amount at a relative pressure p/p₀ of 0.9 is denoted as Va_{0.9}, and in a desorption isotherm of the water-vapor adsorption method, a water-vapor adsorption amount at a relative pressure p/p₀ of 0.5 is denoted as Vd_{0.5}, a relationship of “(Vd_{0.5}−Va_{0.5})/Va_{0.9}≤0.90” is satisfied, a BET specific surface area Sm measured by a nitrogen adsorption method satisfies a relationship of “Sm≤0.8 m²/g”, and a mass proportion W1 of lithium hydroxide and a mass proportion W2 of lithium carbonate satisfy a relationship of “W2/W1≤1.40”.

### TECHNICAL FIELD

The present invention relates to a positive electrode active material for lithium secondary battery, a positive electrode for lithium secondary battery, a lithium secondary battery, and a method for producing a positive electrode active material for lithium secondary battery.

### BACKGROUND ART

In a lithium secondary battery, an electrolyte (such as a non-aqueous electrolyte and a solid electrolyte) is disposed between a positive electrode and an anode. In the lithium secondary battery, charging and discharging are performed by moving lithium ions between the positive electrode and the anode through the electrolyte.

In the lithium secondary battery, the positive electrode is produced by using, for example, a lithium metal composite oxide as a positive electrode active material. The positive electrode active material for lithium secondary battery is produced, for example, by calcining a mixture of a metal composite compound which is a precursor of the lithium metal composite oxide and a lithium compound.

In the above-described calcining, the lithium compound is likely to remain as a residue in the lithium metal composite oxide. The residue of the lithium compound is, for example, an unreacted product of lithium hydroxide which is a raw material, lithium carbonate which is contained as an impurity in the lithium hydroxide which is a raw material, or lithium carbonate which is generated as a by-product during the calcining. The lithium compound as a residue is a factor which causes generation of gas in the lithium secondary battery.

Therefore, it has been proposed to subject a positive electrode active material in which a lithium compound remains in a lithium metal composite oxide as a residue to a water washing treatment (for example, refer to Patent Document 1).

### CITATION LIST

### Patent Documents

Patent Document 1: Japanese Unexamined Patent Application, First Publication No. 2007-273108
Patent Document 2: Japanese Unexamined Patent Application, First Publication No. 2021-39933
Patent Document 3: Japanese Unexamined Patent Application, First Publication No. 2018-14322
Patent Document 4: Japanese Unexamined Patent Application, First Publication No. 2009-99462
Patent Document 5: Japanese Unexamined Patent Application, First Publication No. 2002-348121

### SUMMARY OF INVENTION

### Technical Problem

In the related art, it is not easy to realize a lithium secondary battery which suppresses the generation of gas and has excellent rate performance.

Therefore, an object of the present invention is to provide a positive electrode active material for lithium secondary battery, a positive electrode for lithium secondary battery, a lithium secondary battery, and a method of producing a positive electrode active material for lithium secondary battery, which can easily realize a lithium secondary battery having excellent rate performance while suppressing generation of gas.

### Solution to Problem

The present invention has the following aspects.

[1]

A positive electrode active material for lithium secondary battery, containing:
a lithium metal composite oxide having a layered structure, which contains a Li element, a Ni element, and an element M; and
a lithium compound including lithium hydroxide and lithium carbonate,
in which the element M is at least one element selected from the group consisting of Co, Mn, Fe, Cu, Ti, Mg, Ca, Ba, Al, Zn, Sn, Zr, Nb, B, Si, S, and P,
in a case where, with regard to a water-vapor pressure p and a saturated vapor pressure p₀, in an adsorption isotherm of a water-vapor adsorption method, a water-vapor adsorption amount at a relative pressure p/p₀ of 0.5 is denoted as Va_{0.5} and a water-vapor adsorption amount at a relative pressure p/p₀ of 0.9 is denoted as Va_{0.9}, and in a desorption isotherm of the water-vapor adsorption method, a water-vapor adsorption amount at a relative pressure p/p₀ of 0.5 is denoted as Vd_{0.5}, a relationship represented by the following (expression A) is satisfied,
a BET specific surface area Sm measured by a nitrogen adsorption method satisfies a relationship represented by the following (expression B), and
a mass proportion W1 of the lithium hydroxide and a mass proportion W2 of the lithium carbonate satisfy a relationship represented by the following (expression C),

(Vd_{0.5}−Va_{0.5})/Va_{0.9}≤0.90 (expression A),

Sm≤0.8 m²/g (expression B),

W2/W1≤1.40 (expression C).

[2]

The positive electrode active material for lithium secondary battery according to [1],
in which the lithium metal composite oxide is represented by the following (compositional formula I),

Li[Liₘ(Ni_{(1-x-y)}CoₓM1_{y})₁₋ₘ]O₂ (compositional formula I),

(in the (compositional formula I), M1 is at least one element selected from the group consisting of Mn, Fe, Cu, Ti, Mg, Ca, Ba, Al, Zn, Sn, Zr, B, Si, S, and P, and m, x, and y satisfy relationships represented by −0.1≤m≤0.2, 0≤x≤0.5, 0<y≤0.7, and x+y<1).

[3]

The positive electrode active material for lithium secondary battery according to [1] or [2],
in which the BET specific surface area Sm satisfies a relationship represented by the following expression (B1),

0.2 m²/g≤Sm≤0.7 m²/g (expression B1).

[4]

The positive electrode active material for lithium secondary battery according to any one of [1] to [3],
in which the mass proportion W2 of the lithium carbonate satisfies a relationship represented by the following expression (D),

W2≤0.70% by mass (expression D).

[5]

The positive electrode active material for lithium secondary battery according to any one of [1] to [4],
in which an amount W3 of eluted lithium of the positive electrode active material for lithium secondary battery, which is measured by a neutralization titration method, satisfies a relationship represented by the following expression (E),

W3≤0.50% by mass (expression E).

[6]

The positive electrode active material for lithium secondary battery according to any one of [1] to [5],
in which, in a diffraction pattern of powder X-ray diffraction measured with a CuKα ray, a crystal strain calculated from the diffraction pattern in which a diffraction angle 2θ is included in a range of 10° or more and 90° or less is 0.10° or less.
   [7]

The positive electrode active material for lithium secondary battery according to any one of [1] to [6],
in which an average pore diameter measured by the nitrogen adsorption method is 150 nm or less.
   [8]

The positive electrode active material for lithium secondary battery according to any one of [1] to [7],
in which a pore volume measured by the nitrogen adsorption method is 0.0005 cm³/g or more and 0.0150 cm³/g or less.
   [9]

The positive electrode active material for lithium secondary battery according to any one of [1] to [8],
in which a 50% cumulative volume particle size D₅₀ is 3 μm or more and 30 μm or less.
   [10]

A positive electrode for lithium secondary battery, containing:
the positive electrode active material for lithium secondary battery according to any one of [1] to [9].
   [11]

A lithium secondary battery including:
the positive electrode for lithium secondary battery according to [10].
   [12]

A method for producing a positive electrode active material for lithium secondary battery, including:
a preparation step of preparing a calcined powder of a metal composite compound which is a precursor of a lithium metal composite oxide and a lithium compound;
a humidification step of subjecting the calcined powder prepared in the preparation step to a humidification treatment; and
a drying step of subjecting the calcined powder humidified in the humidification step to a drying treatment to produce the positive electrode active material for lithium secondary battery,
in which, in the humidification step, the humidification treatment is performed in an atmosphere in which a dew point is 50° C. or higher and 90° C. or lower and a CO₂ concentration is 200 ppm or less.
   [13]

The method for producing a positive electrode active material for lithium secondary battery according to [12],
in which, in the humidification step, the humidification treatment is performed in an atmosphere at a temperature of 80° C. or higher and 400° C. or lower.
   [14]

The method for producing a positive electrode active material for lithium secondary battery according to [12] or [13],
in which, in the drying step, the drying treatment is performed in an atmosphere at a temperature of 100° C. or higher and 400° C. or lower.

### Advantageous Effects of Invention

According to the present invention, it is possible to provide a positive electrode active material for lithium secondary battery, a positive electrode for lithium secondary battery, a lithium secondary battery, and a method of producing a positive electrode active material for lithium secondary battery, which can easily realize a lithium secondary battery having excellent rate performance while suppressing generation of gas.

### BRIEF DESCRIPTION OF DRAWINGS

FIG. 1A A view schematically showing a positive electrode active material produced in the related art (a state before a water washing treatment or a humidification treatment is performed).

FIG. 1B A view schematically showing a positive electrode active material produced in the related art (a state after a water washing treatment is performed).

FIG. 1C A view schematically showing a positive electrode active material produced in the related art (a state after a known humidification treatment is performed).

FIG. 2 A diagram showing an example of an adsorption isotherm and a desorption isotherm.

FIG. 3 A flowchart showing an outline of a production method for producing the positive electrode active material for lithium secondary battery according to the embodiment.

FIG. 4 A schematic view showing an example of a lithium secondary battery.

FIG. 5 A schematic view showing an example of an all-solid-state lithium secondary battery.

FIG. 6 A diagram showing an adsorption isotherm and a desorption isotherm used in a case of obtaining a water retention parameter in relation to (Example 1) and (Example C1).

### DESCRIPTION OF EMBODIMENTS

Hereinafter, an example of the embodiment of the present invention will be described.

In the present specification, abbreviations are appropriately used for terms. Specifically, an abbreviation “MCC” is used for representing a metal composite compound. An abbreviation “LiMO” is used for representing a lithium metal composite oxide. An abbreviation “CAM” is used for representing a cathode active material for lithium secondary battery. Regarding a numerical range, for example, in a case of describing “5 to 15 μm”, it means a range from 5 μm to 15 μm, and means a numerical range including the lower limit value of 5 μm and the upper limit value of 15 μm.

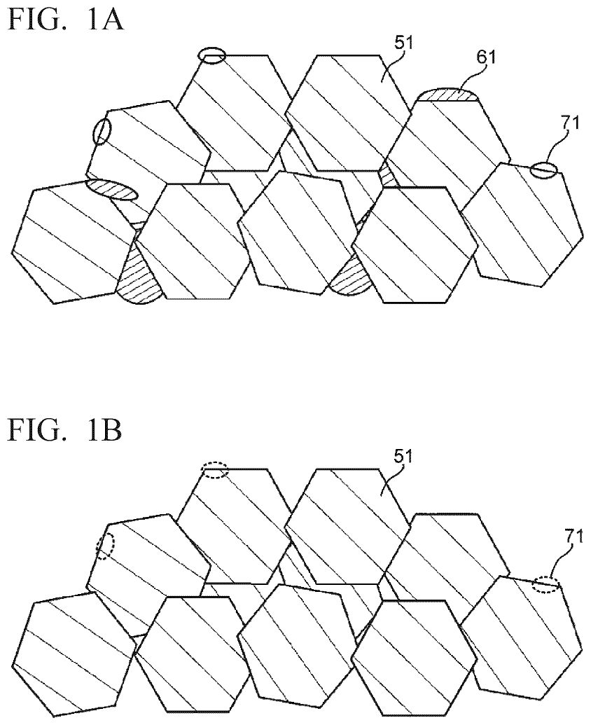

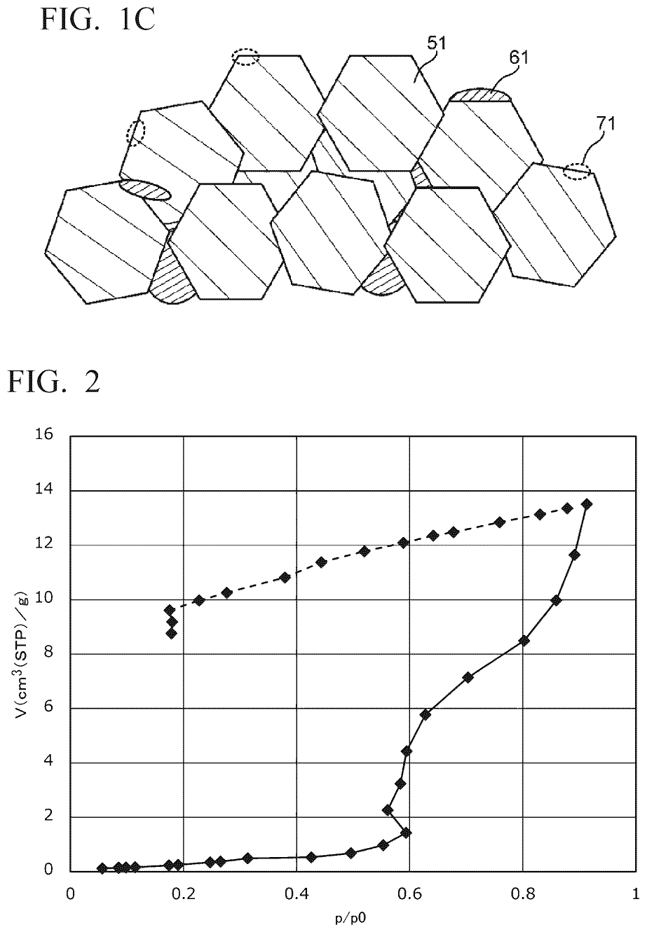

FIGS. 1A to 1C are views schematically showing the CAM according to the related art. FIG. 1A shows a CAM before being subjected to a water washing treatment or a humidification treatment. FIG. 1B shows a CAM after a water washing treatment. FIG. 1C shows a CAM after a humidification treatment.

As shown in FIG. 1A, in the CAM before the water washing treatment or the humidification treatment, a lithium compound 61 remains in a lithium metal composite oxide (LiMO) 51. In addition, in the positive electrode active material before the water washing treatment or the humidification treatment, there is an activation site 71 (in the drawing, a region surrounded by a solid line ellipse) having high water retention and capable of causing a side reaction in LiMO 51.

In a case where the CAM is subjected to a water washing treatment, as shown in FIG. 1B, the lithium compound 61 as a residue is removed from LiMO 51, and a residual amount of the lithium compound 61 is reduced. As a result, it is possible to suppress generation of gas or the like in the lithium secondary battery. In addition, in a case where the water washing treatment is performed, the activation site 71 having high water retention and capable of causing a side reaction in LiMO 51 can be inactivated by contact with water (in the drawing, shown in a region surrounded by a broken line ellipse). However, in a case where the water washing treatment is performed, a BET specific surface area increases with a decrease in the residual amount of the lithium compound 61 from the surface of LiMO 51. As a result, in a charging and discharging cycle of the lithium secondary battery, a large number of side reactions are likely to occur on the surface of LiMO 51, and formation of a resistance layer consisting of a side reaction product and surface deterioration are likely to occur, and thus rate performance may be insufficient.

On the other hand, in a case where a known humidification treatment is performed, as shown in FIG. 1C, the activation site 71 can be inactivated by the contact with water in the same manner as in the case of the water washing treatment (in the drawing, shown in a region surrounded by a broken line ellipse). In addition, in a case where a known humidification treatment is performed, the amount of the lithium compound 61 remaining on the surface of LiMO 51 is not reduced unlike the case of the water washing treatment, and thus it is possible to suppress an excessive increase in the BET specific surface area. As a result, it is possible to obtain a lithium secondary battery having excellent rate performance. However, in a case where the known humidification treatment is performed, the residual amount of the lithium compound 61 is the same before and after the humidification treatment, and thus the generation of gas in the lithium secondary battery may not be sufficiently suppressed. With the CAM according to the present embodiment, it is possible to manufacture a lithium secondary battery in which the generation of gas is suppressed and the rate performance is excellent.

### [A] CAM

In the present embodiment, the CAM contains LiMO and a lithium compound. That is, in the CAM, the lithium compound remains as a residue in LiMO. Each unit constituting the CAM will be sequentially described.

### [A-1] LiMO

In the CAM, the LiMO contains at least a Li element, a Ni element, and an element M. The element M is at least one element selected from the group consisting of Co, Mn, Fe, Cu, Ti, Mg, Ca, Ba, Al, Zn, Sn, Zr, Nb, B, Si, S, and P. The element M is preferably at least one element selected from the group consisting of Co, Mn, Al, Zr, Nb, and B.

Specifically, the LiMO is preferably represented by the following (compositional formula I).

Li[Liₘ(Ni_{(1-x-y)}CoₓM1_{y})₁₋ₘ]O₂ (Compositional formula I)

In the (compositional formula I), an element M1 is at least one element selected from the group consisting of Mn, Fe, Cu, Ti, Mg, Ca, Ba, Al, Zn, Sn, Zr, Nb, B, Si, S, and P. That is, the element M1 is an element other than a Co element among the above-described elements M. The element M1 is preferably at least one element selected from the group consisting of Mn, Al, Zr, Nb, and B.

In addition, in the (compositional formula I), it is preferable that each of m, x, and y satisfies relationships represented by the following (expression Ia) to (expression Id).

−0.1≤m≤0.2 (Expression Ia)

0≤x≤0.5 (Expression Ib)

0<y≤0.7 (Expression Ic)

x+y<1 (Expression Id)

In the (compositional formula I), in a case where the value of m is equal to or more than the lower limit value of the range represented by the (expression Ia), the rate performance of the lithium secondary battery can be improved. In addition, in the (compositional formula I), in a case where the value of m is equal to or less than the upper limit value of the range represented by the (expression Ia), an initial coulombic efficiency of the lithium secondary battery can be improved. In addition, in the (compositional formula I), m is more preferably −0.03 or more, and particularly preferably 0 or more. Furthermore, m is more preferably 0.1 or less, and particularly preferably 0.07 or less. The range of m is more preferably −0.03≤m≤0.1 and particularly preferably 0≤m≤0.07.

In the (compositional formula I), in a case where the value of x satisfies the relationship represented by the (expression Ib), an internal resistance of the lithium secondary battery can be reduced and the rate performance can be improved. In addition, in the (compositional formula I), x is more preferably 0.01 or more, and particularly preferably 0.02 or more. Furthermore, x is more preferably 0.4 or less, and particularly preferably 0.3 or less. The range of x is more preferably 0.01≤x≤0.4 and particularly preferably 0.02≤x≤0.3.

In the (compositional formula I), in a case where the value of y satisfies the relationship represented by the (expression Ic), a cycle retention rate of the lithium secondary battery can be improved. In addition, in the (compositional formula I), y is more preferably 0.0002 or more, and particularly preferably 0.0005 or more. Furthermore, y is more preferably 0.6 or less, and particularly preferably 0.5 or less. The range of y is more preferably 0.0002≤y≤0.6, and particularly preferably 0.0005≤y≤0.5.

In the (compositional formula I), in a case where the added value (x+y) of the value of x and the value of y satisfies the relationship represented by the (expression Id), an initial capacity of the lithium secondary battery can be improved. In order to suppress the increase in internal resistance of the lithium secondary battery and the decrease in rate performance, the added value (x+y) of the value of x and the value of y is preferably 0.01 or more. In addition, in the (compositional formula I), (x+y) is more preferably less than 0.6, particularly preferably 0.5 or less, and still more preferably 0.25 or less. The range of (x+y) is 0<x+y<1, and is more preferably 0.01≤x+y<0.6, particularly preferably 0.01≤x+y≤0.5, and still more preferably 0.01≤x+y≤0.25.

### (Measurement of Composition)

A composition of the LiMO is determined, for example, by measuring the CAM using an ICP emission spectrometer (Optima 7300 (manufactured by PerkinElmer, Inc.) or the like). It is noted that m of the (compositional formula I) may also include Li derived from the lithium compound in addition to Li derived from the LiMO. Before the composition is measured, a treatment of dissolving the sample in an acid or an alkali is performed according to the measurement element.

The LiMO has a layered structure.

A crystal structure of the LiMO is preferably a layered rock-salt structure, and more preferably a hexagonal crystal structure or a monoclinic crystal structure. Specifically, the hexagonal crystal structure belongs to one space group selected from the group consisting of P3, P3₁, P3₂, R3, P-3, R-3, P312, P321, P3₁12, P3₁21, P3₂12, P3₂21, R32, P3m1, P31m, P3c1, P31c, R3m, R3c, P-31m, P-31c, P-3 m1, P-3c1, R-3m, R-3c, P6, P6₁, P6₅, P6₂, P6₄, P6₃, P-6, P6/m, P63/m, P622, P6₁22, P6₅22, P6₂22, P6₄22, P6₃22, P6 mm, P6cc, P6₃ cm, P6₃mc, P-6m2, P-6c2, P-62m, P-62c, P6/mmm, P6/mcc, P6₃/mcm, and P6₃/mmc. In addition, the monoclinic crystal structure belongs to one space group selected from the group consisting of P2, P2₁, C2, Pm, Pc, Cm, Cc, P2/m, P2₁/m, C2/m, P2/c, P2₁/c, and C2/c. Among the above, in order to obtain a lithium secondary battery having a high discharge capacity and excellent rate performance, the crystal structure of the LiMO is particularly preferably a hexagonal crystal structure belonging to a space group R-3m or a monoclinic crystal structure belonging to C2/m.

The crystal structure of the LiMO can be calculated by performing a powder X-ray diffraction measurement of the CAM using CuKα as a radiation source and a measurement range of a diffraction angle 2θ of 10° to 90°. Specifically, the crystal structure of the LiMO can be confirmed by observation using a powder X-ray diffractometer (for example, Ultima IV manufactured by Rigaku Corporation).

### [A-2] Lithium Compound

In the CAM, the lithium compound is a residue remaining in the LiMO during the production of the CAM, and includes lithium hydroxide and lithium carbonate.

Specifically, the lithium compound as a residue is an unreacted product of lithium hydroxide which is a raw material, lithium carbonate which is contained as an impurity in the lithium hydroxide which is a raw material, lithium carbonate which is generated as a by-product during the calcining, or the like.

### [A-3] Characteristics of CAM

The CAM is a powder in which a plurality of particles are aggregated. Although details will be described later, the powder of the CAM is a calcined powder.

The powder of the CAM may be composed of only secondary particles in which primary particles are aggregated, or both the primary particles and the secondary particles may be mixed. For example, the powder of the CAM may include LiMO which is secondary particles and primary particles of the lithium compound.

The above-described “primary particles” are particles in which grain boundaries are not present in appearance in a case where the CAM is observed with a microscope (such as a scanning electron microscope) in a field of view of 1,000 times to 30,000 times. The above-described “secondary particles” are aggregates of the primary particles.

The CAM satisfies the following (requirement 1), (requirement 2), and (requirement 3). In a case where the CAM satisfies the (requirement 1), (requirement 2), and (requirement 3), it is possible to easily realize a lithium secondary battery having excellent rate performance while suppressing the generation of gas.

### [A-3-1](Requirement 1) Water Retention Parameter

In the CAM, in a case where, with regard to a water-vapor pressure p and a saturated vapor pressure p₀, in an adsorption isotherm of a water-vapor adsorption method, a water-vapor adsorption amount at a relative pressure p/p₀ of 0.5 is denoted as Va_{0.5} and a water-vapor adsorption amount at a relative pressure p/p₀ of 0.9 is denoted as Va_{0.9}, and in a desorption isotherm of the water-vapor adsorption method, a water-vapor adsorption amount at a relative pressure p/p₀ of 0.5 is denoted as Vd_{0.5}, a relationship of the (requirement 1) represented by the following (expression A) is satisfied.

(Vd_{0.5}−Va_{0.5})/Va_{0.9}≤0.90 (Expression A)

(Vd_{0.5}−Va_{0.5})/Va_{0.9} defines a water retention parameter indicating water retention, and means that water is difficult to retain as the value decreases. In a case where the relationship represented by the (expression A) is satisfied, the activation site in the CAM, which is likely to cause a side reaction, is effectively inactivated by the contact with water. It is considered that Ni which is active on the CAM surface is inactivated by the contact with water to have a NiO—OH structure. Therefore, the lithium secondary battery produced by using the CAM satisfying the relationship represented by the (expression A) can sufficiently suppress the generation of gas.

From the viewpoint described above, the water retention parameter more preferably satisfies an expression (A1).

(Vd_{0.5}−Va_{0.5})/Va_{0.9}≤0.85 (Expression A1)

The water-vapor pressure p and the saturated vapor pressure p₀ in the measurement are values in a case where a temperature is 25° C. The Va_{0.5}, Va_{0.9}, and Vd_{0.5} are amounts (unit: cm³ (STP)/g) of water vapor adsorbed by the CAM sample per unit mass (for example, 1 g).

### (Measurement of Water Retention Parameter)

The adsorption isotherm and the desorption isotherm are obtained by measuring a water-vapor adsorption amount at which the sample adsorbs water vapor while changing the condition of the relative pressure p/p₀. The water-vapor adsorption amount is measured by performing a water-vapor adsorption method using a vapor adsorption measuring device. The vapor adsorption measuring device is, for example, “BELSORP (registered trademark)-18” manufactured by MicrotracBEL Corp., and the water-vapor adsorption amount is measured under the following measurement conditions.
Filling sample amount: 0.5 g
Pre-processing conditions of sample: treatment at 200° C. for 5 hours under vacuum
Constant temperature bath temperature: 50° C.
Adsorption temperature: 25° C.
Saturated vapor pressure: 3.169 kPa
Adsorption equilibrium time: 500 seconds

FIG. 2 is a diagram showing an example of the adsorption isotherm and the desorption isotherm. In FIG. 2, a horizontal axis represents the relative pressure p/p₀, and the vertical axis represents the water-vapor adsorption amount V (cm³ (STP)/g). In FIG. 2, the adsorption isotherm is indicated by a solid line, and the desorption isotherm is indicated by a broken line.

As shown in FIG. 2, in the present embodiment, the adsorption isotherm (solid line) is a locus of the water-vapor adsorption amount V measured in a case where p/pₒ is increased to 0.9. In the adsorption isotherm, V increases as p/pₒ increases. On the other hand, the desorption isotherm (broken line) is a locus of V measured in a case where p/pₒ is increased to a point exceeding 0.9, in order to obtain the adsorption isotherm in the present embodiment and then decreased from the point. In the desorption isotherm, V decreases as p/pₒ decreases.

As can be seen from FIG. 2, the adsorption isotherm and the desorption isotherm do not coincide with each other. For example, V (that is, Va_{0.5}) in a case where p/pₒ is 0.5 in the adsorption isotherm is smaller than V (that is, Vd_{0.5}) in a case where p/pₒ is 0.5 in the desorption isotherm (Va_{0.5}<Vd_{0.5}). That is, a value obtained by subtracting Va_{0.5} from Vd_{0.5} is larger than zero (Vd_{0.5}−Va_{0.5}>0). As described above, there is hysteresis between the adsorption and desorption of water vapor.

The (Vd_{0.5}−Va_{0.5})/Va_{0.9} is a value obtained by dividing the value (Vd_{0.5}−Va_{0.5}) obtained by subtracting Va_{0.5} from Vd_{0.5} by Va_{0.9} at which the water-vapor adsorption amount is maximized; and is an index indicating a degree of hysteresis, that is, a water retention parameter (water retention index), and means that water is difficult to be retained as the value decreases.

The lower limit value of the (Vd_{0.5}−Va_{0.5})/Va_{0.9} is not particularly limited, but it may be (Vd_{0.5}−Va_{0.5})/Va_{0.9}>0 or may be (Vd_{0.5}−Va_{0.5})/Va_{0.9}>0.1. The range of (Vd_{0.5}−Va_{0.5})/Va_{0.9} is preferably 0<(Vd_{0.5}−Va_{0.5})/Va_{0.9}≤0.90, 0<(Vd_{0.5}−Va_{0.5})/Va_{0.9}≤0.85, and particularly preferable 0.1<(Vd_{0.5}−Va_{0.5})/Va_{0.9}≤0.85.

### [A-3-2](Requirement 2) BET Specific Surface Area Sm

In the CAM, a BET specific surface area Sm measured by a nitrogen adsorption method satisfies a relationship of the (requirement 2) represented by the following (expression B).

Sm≤0.8 m²/g (Expression B)

In a case where the relationship represented by the (expression B) is satisfied, the occurrence of a resistance layer or surface deterioration due to the side reaction on the CAM surface is suppressed, so that, in the charging and discharging cycle of the lithium secondary battery, it is possible to sufficiently suppress the occurrence of the side reaction on the surface of the CAM. As a result, the rate performance of the lithium secondary battery can be improved. From the viewpoint described above, the Sm is preferably 0.2 m²/g≤Sm≤0.8 m²/g.

From the viewpoint described above, it is still more preferable that the Sm satisfies a relationship represented by the following expression (B1).

0.2 m²/g≤Sm≤0.7 m²/g (Expression B1)

In a case where the value of the (expression B1) is equal to or more than the lower limit value, a surface reaction field of the CAM is sufficiently present, and thus the rate performance of the lithium secondary battery can be improved.

### (Measurement of Sm)

The Sm is a value which is measured by the Brunauer-Emmett-Teller (BET) method. In the measurement of the Sm, a nitrogen gas is used as an adsorbed gas. The BET specific surface area (unit: m²/g) is measured, for example, by drying 1 g of the CAM at a temperature condition of 105° C. for 30 minutes in a nitrogen atmosphere, and then performing measurement using a BET specific surface area meter (for example, Macsorb (registered trademark) manufactured by MOUNTECH Co., Ltd.).

### [A-3-3](Requirement 3) W2/W1

In the CAM, a mass proportion W1 of the lithium hydroxide and a mass proportion W2 of the lithium carbonate satisfy a relationship of the (requirement 3) represented by the following (expression C).

W2/W1≤1.40 (Expression C)

In a case where the relationship represented by the (expression C) is satisfied, the amount of the lithium carbonate in the lithium compound contained in the CAM is not excessive as compared with the amount of the lithium hydroxide. As a result of various studies, it is found that the lithium carbonate is more likely to contribute to the amount of gas generated (cc/g) derived from the side reaction of the lithium secondary battery as compared with the lithium hydroxide. The CAM satisfying the above (expression C) means that the mass proportion of the lithium carbonate contained in the lithium compound is low. Therefore, the generation of gas in the lithium secondary battery can be sufficiently suppressed.

From the viewpoint described above, it is still more preferable that the W1 and W2 satisfy a relationship represented by the following expression (C1).

W2/W1≤1.00 (Expression C1)

The lower limit value of the W2/W1 is not particularly limited, but it may be W2/W1≥0 or may be W2/W1>0. Examples of the range of W2/W1 include 0≤W2/W1≤1.40, 0≤W2/W1≤1.00, 0<W2/W1≤1.40, and 0<W2/W1≤1.00.

In the CAM, it is preferable that the W2 satisfies a relationship represented by the following expression (D).

W2≤0.70% by mass (Expression D)

By satisfying the (expression D), it is possible to suppress the generation of gas due to the side reaction of lithium carbonate.

From the viewpoint described above, it is more preferable to satisfy a relationship represented by the following expression (D1).

W2≤0.60% by mass (Expression D1)

The lower limit value of the W2 is not particularly limited, but it may be W2≥0% by mass or may be W2>0% by mass. Examples of the range of W2 include 0% by mass≤W2≤0.70% by mass, 0% by mass≤W2≤0.60% by mass, 0% by mass<W2≤0.70% by mass, and 0% by mass<W2≤0.60% by mass.

In addition, in the CAM, it is preferable that an amount W3 of eluted lithium measured by a neutralization titration method satisfies a relationship represented by the following expression (E).

W3≤0.50% by mass (Expression E)

By satisfying the (expression E), it is possible to suppress the generation of gas due to the side reaction of the lithium compound.

From the viewpoint described above, it is more preferable to satisfy a relationship represented by the following expression (E1).

W3≤0.40% by mass (Expression E1)

The lower limit value of W3 is not particularly limited, but it may be W3>0% by mass. The range of W3 is particularly preferably 0% by mass<W3≤0.50% by mass, and still more preferably 0% by mass≤W3≤0.40% by mass.

### (Neutralization Titration Method)

The W1 and W2 are measured by a neutralization titration method.

In a case of measuring the W1 and W2, first, 5 g of the CAM and 100 g of pure water are put into a 100 mL polypropylene container to produce a slurry. After putting a stirrer inside the container containing the slurry, the slurry is stirred for 5 minutes in a state in which the container is sealed. After completion of the stirring, the slurry is filtered.

Hydrochloric acid having a concentration of 0.1 mol/L is continuously added dropwise to 60 g of a filtrate obtained by filtering the slurry. The hydrochloric acid is added dropwise until the pH reaches 4.0 using an automatic titrator (manufactured by KYOTO ELECTRONICS MANUFACTURING CO., LTD., AT-610). In this case, in the filtrate to which the hydrochloric acid is added dropwise, an amount A [mL] of hydrochloric acid added dropwise at a pH of 8.3±0.1 and an amount B [mL] of hydrochloric acid added dropwise at a pH of 4.5±0.1 are determined.

Thereafter, the W1 and W2 are calculated using the following (expression b) and (expression c). In the (expression b) and (expression c), a molecular weight of the lithium hydroxide and a molecular weight of the lithium carbonate are calculated by setting the atomic weight to H: 1.000, Li: 6.941, C: 12, and O: 16 (that is, the molecular weight of the lithium hydroxide: 23.941, the molecular weight of the lithium carbonate: 73.882).

W1 [% by mass]={0.1×(2A−B)/1000}×{23.941/(20×60/100)}×100 (Expression b)

W2 [% by mass]={0.1×(B−A)/1000}×{73.882/(20×60/100)}×100 (Expression c)

The W3 can be obtained using (expression d) from the results of W1 and W2 calculated as described above.

W3 [% by mass]=W2×(2×6.941/73.882)+W1×(6.941/23.941) (Expression d)

### [A-3-4] Other Characteristics

### [A-3-4-1] Crystal Strain

In the CAM, it is preferable that, in a diffraction pattern of powder X-ray diffraction measured with a CuKα ray, a crystal strain calculated from the diffraction pattern in which a diffraction angle 2θ is included in a range of 10° to 90° is 0.10° or less. As a result, diffusion of lithium ions in a plane direction of the layered structure of the LiMO contained in CAM is facilitated, the diffusion resistance of the lithium ions is reduced, and thus the rate performance can be improved.

From the viewpoint described above, the above-described crystal strain is more preferably 0.08° or less.

The crystal strain is measured by powder X-ray diffraction. The powder X-ray diffraction is performed under the following measurement conditions using an X-ray diffractometer (for example, D8 Advance manufactured by Bruker).

### (Measurement Conditions)

Sampling width: 0.02
Scan speed: 4°/min

The powder X-ray diffraction is performed using a CuKα ray under a condition that the measurement range of the diffraction angle 2θ is 10° or more and 90° or less. The crystal strain can be obtained by analyzing the diffraction pattern obtained by performing the powder X-ray diffraction according to the Rietveld analysis method. The Rietveld analysis is a method of comparing a measured powder X-ray diffraction pattern with a simulation pattern from a crystal structure model and optimizing a crystal structure parameter in the crystal structure model such that the difference between the measured powder X-ray diffraction pattern and the simulation pattern is minimized. The crystal strain is optimized by using a layered rock-salt crystal structure (Li₁₋ₙMeₙ)(Me₁₋ₘLiₙ)O₂ as an initial crystal structure model.

### [A-3-4-2] Average Pore Diameter and Pore Volume

It is preferable that an average pore diameter of the CAM measured by the nitrogen adsorption method is 150 nm or less. In this manner, a decrease in electrode density can be prevented, and a battery having a high energy density can be obtained. In addition, permeability and retention of an electrolytic solution can be sufficiently exhibited, and thus the rate performance can be improved.

From the viewpoint described above, the above-described average pore diameter is more preferably 100 nm or less, and particularly preferably 60 nm or less. In addition, the above-described average pore diameter is preferably 10 nm or more. The range of the average pore diameter is more preferably 10 to 150 nm, particularly preferably 10 to 100 nm, and still more preferably 10 to 60 nm.

In addition, it is preferable that a pore volume of the CAM measured by the nitrogen adsorption method is 0.0005 to 0.015 cm³/g. In a case where the pore volume is equal to or more than the lower limit value of the above-described range, permeability and retention of an electrolytic solution can be sufficiently exhibited, and thus the rate performance can be improved. In addition, in a case where the pore volume is equal to or less than the upper limit value of the above-described range, the density of the CAM is improved, and thus the energy density is likely to be improved.

From the viewpoint described above, the lower limit value of the pore volume is more preferably 0.001 cm³/g, and the upper limit value thereof is more preferably 0.010 cm³/g. Examples of the range of the pore volume include 0.001 to 0.015 cm³/g, 0.0005 to 0.010 cm³/g, and 0.0010.010 cm³/g.

The average pore diameter and the pore volume are calculated based on a pore diameter distribution obtained by analyzing an adsorption isotherm and a desorption isotherm obtained by performing a nitrogen adsorption method according to the Barrett-Joyner-Halenda (BJH) method. The BJH method is a method of performing analysis on the assumption that the pore shape is a cylindrical shape, based on a relational expression (Kelvin equation) between the pore diameter which causes capillary condensation and the relative pressure of nitrogen. The pore size distribution determined from the desorption isotherm derives from bottleneck type pores.

In a case of measuring the adsorption isotherm and the desorption isotherm described above, first, a vacuum degassing treatment is performed on 10 g of a sample under conditions of 150° C. and 8 hours using a vacuum heating treatment apparatus (for example, BELSORP-vac II manufactured by MicrotracBEL Corp.). After the vacuum degassing treatment is performed, using a measuring device (for example, BELSORP-mini manufactured by MicrotracBEL Corp.), an adsorption isotherm and a desorption isotherm of nitrogen are obtained at a temperature of liquid nitrogen (77 K). The nitrogen adsorption amount at which the sample adsorbs nitrogen per unit mass on the adsorption isotherm and the desorption isotherm is calculated so as to be expressed in a volume of nitrogen gas at a standard state (Standard Temperature and Pressure; STP).

### [A-3-4-3] 50% Cumulative Volume Particle Size D₅₀

It is preferable that a 50% cumulative volume particle size D₅₀ (hereinafter, may be described as D₅₀) of the CAM is 3 to 30 μm. In a case where the D₅₀ is within the range, a bulk density can be increased, and thus a filling density can be increased. As a result, in the positive electrode for lithium secondary battery, a contact area between particles of the CAM and particles of a conductive material is increased, and conductivity is improved, so that the rate performance of the lithium secondary battery can be improved. The D₅₀ of the CAM is more preferably 5 μm or more, particularly preferably 7 μm or more, and still more preferably 8 μm or more. The D₅₀ is more preferably 25 μm or less, particularly preferably 23 μm or less, and still more preferably 20 μm or less. The D₅₀ is more preferably 5 to 25 μm, particularly preferably 7 to 23 μm, and still more preferably 8 to 20 μm.

The D₅₀ is measured by a laser diffraction scattering method. Specifically, in a case of measuring the D₅₀, first, a dispersion liquid in which powder of the CAM is dispersed is obtained. The dispersion liquid is prepared by putting 0.1 g of powder of the CAM into 50 ml of a sodium hexametaphosphate aqueous solution (concentration: 0.2% by mass). Next, a laser diffraction scattering particle size distribution analyzer (for example, manufactured by MicrotracBEL Corp., Microtrac MT3300EXII) is used for measuring a particle size distribution of the powder in the dispersion liquid to obtain a volume-based cumulative particle size distribution curve. The D₅₀ (μm) corresponds to the value of a particle diameter at 50% cumulative from the fine particle side in the cumulative particle size distribution curve.

### [B] Method for Producing CAM

A production method for producing the CAM will be described.

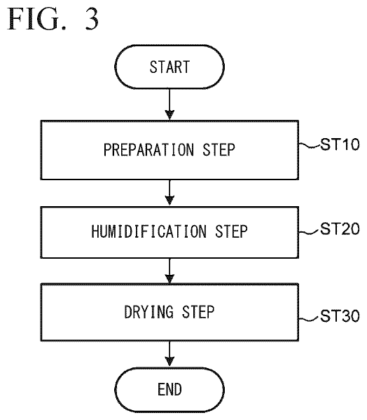

FIG. 3 is a flowchart showing an outline of a production method for producing the CAM according to the embodiment.

In a case of producing the CAM, as shown in FIG. 3, a preparation step (ST10), a humidification step (ST20), and a drying step (ST30) are sequentially executed.

### [B-1] Preparation Step (ST10)

In the preparation step (ST10), a calcined powder of MCC which is a precursor of the LiMO and the lithium compound is prepared.

Specifically, a composition of the MCC contains a Ni element, a Co element, and the above-described element M1 at a mole ratio represented by the following (formula II).

[Ni]:[Co]:[M1]=(1−x−y):x:y (Formula II)

In the (formula II), it is preferable that each of x and y satisfies relationships represented by the following (expression IIb) to (expression IId) (same as the (expression Ib) to (expression Id) relating to the (compositional formula I) described above).

0≤x≤0.5 (Expression IIb)

0<y≤0.7 (Expression IIc)

x+y<1 (Expression IId)

### [B-1-1] MCC

The MCC is, for example, a metal composite hydroxide, a metal composite oxide, or a mixture thereof.

The metal composite hydroxide is produced, for example, by a known batch co-precipitation method or a continuous co-precipitation method. Hereinafter, a method for producing the MCC will be described in detail using a metal composite hydroxide containing Ni, Co, and Al as metal elements as an example.

Specifically, a nickel salt solution, a cobalt salt solution, an aluminum salt solution, and a complexing agent are reacted with each other by a continuous co-precipitation method described in JP-A-2002-201028. As a result, a metal composite hydroxide (Ni_{(1-x-y)}CoₓAl_{y}(OH)₂) containing the Ni element, the Co element, and the element M1 at the mole ratio represented by the (formula II) described above is produced.

A nickel salt, which is a solute of the nickel salt solution, is, for example, at least one of nickel sulfate, nickel nitrate, nickel chloride, or nickel acetate.

A cobalt salt, which is a solute of the cobalt salt solution, is, for example, at least one of cobalt sulfate, cobalt nitrate, cobalt chloride, or cobalt acetate.

An aluminum salt, which is a solute of the aluminum salt solution, is, for example, at least one of aluminum sulfate, aluminum nitrate, aluminum chloride, or aluminum acetate.

The above-described metal salts are mixed at a ratio. That is, in the mixed solution containing the above-described metal salts, the mole ratio of each element corresponds to the (formula II) described above. Here, water is used as a solvent.

In the production step of the metal composite hydroxide, a complexing agent may be used. In this case, a mole ratio of an amount of the complexing agent to the total number of moles of the metal salts (the nickel salt, the cobalt salt, and the aluminum salt) is more than 0 and 2.0 or less.

The complexing agent is a material capable of forming a complex with nickel ions, cobalt ions, and aluminum ions in an aqueous solution. The complexing agent is, for example, at least one of ammonium ion donors (ammonium hydroxide, ammonium sulfate, ammonium chloride, ammonium carbonate, ammonium fluoride, or the like), hydrazine, ethylenediaminetetraacetic acid, nitrilotriacetic acid, uracildiacetic acid, or glycine.

In the co-precipitation method, a pH value of the mixed solution containing the nickel salt solution, the cobalt salt solution, the aluminum salt solution, and the complexing agent is adjusted. Therefore, an alkali metal hydroxide is added to the mixed solution before the pH of the mixed solution changes from alkaline to neutral. The alkali metal hydroxide is, for example, sodium hydroxide or potassium hydroxide.

Here, the pH value is measured at a temperature of 40° C. of the mixed solution. The pH of the mixed solution is measured in a case where the temperature of the mixed solution sampled from a reaction vessel reaches 40° C. In a case where the sampled mixed solution is not 40° C., the mixed solution is heated or cooled to 40° C., and then the pH is measured.

In addition to the nickel salt solution, the cobalt salt solution, and the aluminum salt solution described above, the complexing agent is continuously supplied to the reaction vessel, whereby a reaction occurs and Ni_{(1-x-y)}CoₓAl_{y}(OH)₂ is generated.

Here, a temperature of the reaction vessel is controlled, for example, in a range of 20° C. to 80° C., preferably in a range of 30° C. to 70° C.

In addition, in the reaction, the pH value in the reaction vessel is controlled, for example, in a range of 9 to 13.

A reaction precipitate formed in the reaction vessel is neutralized in a state of being stirred. A time for neutralizing the reaction precipitate is, for example, in a range of 1 to 20 hours.

As the reaction vessel used in the continuous co-precipitation method, a reaction vessel of a type in which an overflow occurs can be used in order to separate the formed reaction precipitate.

In a case of producing the metal composite hydroxide by a batch co-precipitation method, a reaction vessel which does not include a overflow pipe, a device that has a mechanism for concentrating the overflowed reaction precipitate in a concentrating tank connected to the overflow pipe and circulating it back to the reaction vessel, or the like is used.

Here, various gases (for example, an inert gas such as nitrogen, argon, and carbon dioxide, an oxidizing gas such as an air and oxygen, or a mixed gas thereof) may be supplied into the reaction vessel.

After the above-described reaction is completed, the neutralized reaction precipitate is washed and isolated. The isolation is performed, for example, by a method of dewatering a slurry containing the reaction precipitate by centrifugal separation, suction filtration, or the like.

The isolated reaction precipitate is dried and sieved as necessary to obtain the metal composite hydroxide.

The reaction precipitate is preferably washed with water or an alkaline washing liquid. In the washing of the reaction precipitate, an alkaline washing liquid is preferably used, and in particular, a sodium hydroxide aqueous solution is preferably used as the alkaline washing liquid. In addition, the washing may be performed using a washing liquid containing a sulfur element. The washing liquid containing a sulfur element is an aqueous solution of a sulfate of potassium or sodium.

In the above-described example, the metal composite hydroxide is produced as the MCC, but the metal composite oxide may be prepared.

The metal composite oxide is produced, for example, by heating the metal composite hydroxide. The heating step may be performed a plurality of times as necessary. In the heating step, a heating temperature means a set temperature of the heating device, and in a case where a plurality of heating steps are performed, the heating temperature means a temperature of a step in which heating is performed at the highest retention temperature, among the plurality of heating steps.

The heating temperature is preferably in a range of 400° C. to 700° C. and more preferably in a range of 450° C. to 680° C. In this manner, a metal composite oxide in which the metal composite hydroxide is sufficiently oxidized and the BET specific surface area is in an appropriate range is obtained.

A time for which the heating temperature is maintained in the heating step is preferably in a range of 0.1 to 20 hours and more preferably in a range of 0.5 to 10 hours. A temperature rising rate until the above-described heating temperature is reached is, for example, in a range of 50 to 400° C./hour. In addition, the heating treatment is performed in an atmosphere including air, oxygen, nitrogen, argon, or a mixed gas thereof.

The inside of the heating device may be in an oxygen-containing atmosphere which appropriately contains oxygen. The oxygen-containing atmosphere may be a mixed gas atmosphere of an inert gas and an oxidizing gas, or may be a state in which an oxidizing agent is present in an inert gas atmosphere. As a result, a transition metal contained in the metal composite hydroxide is appropriately oxidized, and thus the form of the metal composite oxide is easily controlled.

In the oxygen-containing atmosphere, it is sufficient that a sufficient amount of oxygen atoms for oxidizing the transition metal is present.

In a case where the oxygen-containing atmosphere is a mixed gas atmosphere including an inert gas and an oxidizing gas, the atmosphere in the heating device is controlled by a method of allowing the oxidizing gas to pass through the heating device, a method of bubbling the oxidizing gas in the mixed solution, or the like.

The oxidizing agent present in the oxygen-containing atmosphere is a peroxide such as hydrogen peroxide, a peroxide salt such as permanganate, a perchlorate, a hypochlorite, a nitric acid, a halogen, an ozone, or the like.

### [B-1-2] Lithium Compound

The lithium compound used in the production of the LiMO is, for example, at least one of lithium carbonate, lithium nitrate, lithium acetate, lithium hydroxide, lithium hydroxide hydrate, lithium oxide, lithium chloride, or lithium fluoride. Among these, lithium hydroxide, lithium hydroxide hydrate, a mixture of lithium hydroxide and lithium carbonate, or a mixture of lithium hydroxide hydrate and lithium carbonate is preferably used as the lithium compound. In addition, in a case where lithium hydroxide contains lithium carbonate, a content of the lithium carbonate in the lithium hydroxide is preferably 5% by mass or less.

### [B-1-3] Mixing

The MCC and lithium compound are mixed at a ratio in consideration of the compositional ratio of the final objective product.

### [B-1-4] Calcining

A calcining treatment is performed on the mixture of the MCC and the lithium compound to produce a calcined product.

A calcining temperature is preferably in a range of 650° C. to 1,000° C., more preferably in a range of 680° C. to 900° C., and particularly preferably in a range of 700° C. to 850° C. In a case where the calcining temperature is 650° C. or higher, CAM having a firm crystal structure can be obtained. In addition, in a case where the calcining temperature is 1,000° C. or lower, volatilization of lithium ions on the particle surface of the CAM can be reduced.

In addition, a primary particle diameter of the CAM to be obtained can be controlled by adjusting a retention time of the calcining treatment. As the retention time increases, the primary particle diameter tends to increase and the BET specific surface area tends to decrease. The above-described retention time is appropriately adjusted depending on the kind of the transition metal element to be used and the kind and amount of a precipitant.

Specifically, the retention time of the calcining treatment is preferably 0.5 to 50 hours and more preferably 1 to 20 hours. In a case where the retention time of the calcining treatment is 50 hours or less, it is possible to suppress a substantial decrease in battery performance due to the volatilization of lithium ions. In a case where the retention time of the calcining treatment is 0.5 hours or more, development of crystals is sufficient, and the battery performance is less likely to deteriorate.

A temperature rising rate until the calcining temperature is reached is preferably 80° C./hour or more, more preferably 100° C./hour or more, and particularly preferably 150° C./hour or more. The temperature rising rate until the calcining temperature is reached is calculated from a time taken from a time when the temperature rising is started to a time when the calcining temperature is reached in the calcining device.

The calcining treatment preferably has a plurality of calcination stages which are carried out at different calcining temperatures. For example, it is preferable that the calcining treatment has a first calcining stage and a second calcining stage in which the calcining is performed at a higher temperature than the first calcining stage. Furthermore, the calcining treatment may have calcining stages in which the calcining temperature and the calcining time are different.

The calcining treatment is performed in an atmosphere including air, oxygen, nitrogen, argon, a mixed gas thereof, or the like, depending on a desired composition.

The mixture of the MCC and the lithium compound may be calcined in the presence of an inert melting agent. The inert melting agent is added to the extent that the initial capacity of the battery using the CAM is not impaired, and may remain in the calcined product. As the inert melting agent, for example, those described in WO2019/177032A1 can be used.

The mixture may be subjected to a preliminary calcining treatment before the above-described calcining treatment. The preliminary calcining treatment is performed at a temperature lower than the calcining temperature in the calcining treatment. The calcining temperature of the preliminary calcining treatment is, for example, in a range of 400° C. or higher and lower than 700° C. The preliminary calcining treatment may be performed a plurality of times.

The calcining device used for the preliminary calcining is not particularly limited, and is, for example, a continuous calcining furnace or a fluidized calcining furnace. The continuous calcining furnace is, for example, a tunnel furnace or a roller hearth kiln. The fluidized calcining furnace is, for example, a rotary kiln.

### [B-1-5] Crushing

The calcined product obtained by the above-described calcining is subjected to a crushing treatment. As a result, a calcined powder is produced from the calcined product.

The crushing treatment may be performed a plurality of times. For example, in a case where the first calcining stage and the second calcining stage are sequentially performed for the calcining treatment, a first crushing treatment may be performed after the first calcining stage is performed, and a second crushing treatment may be further performed after the second calcining stage is performed.

[B-2] Humidification step (ST20)

Next, in the humidification step (ST20), the calcined powder prepared in the preparation step (ST10) is subjected to a humidification treatment.

In the humidification step (ST20), it is preferable to perform the humidification treatment in an atmosphere having a dew point of 50° C. to 90° C. In a case where the dew point is equal to or more than the above-described lower limit value in the execution of the humidification treatment, a sufficient humidification treatment can be performed. In addition, in a case where the dew point is equal to or less than the above-described upper limit value, the amount of moisture in contact with the CAM is small, and the lithium hydroxide or the lithium carbonate, generated by extracting Li from the inside of the CAM, is hardly generated as a residue in a large amount, and thus the generation of gas in the lithium secondary battery can be sufficiently suppressed.

From such a viewpoint, the dew point of the humidification treatment is more preferably 60° C. or higher and particularly preferably 80° C. or lower. Examples of the range of the dew point of the humidification treatment include 60° C. to 90° C., 50° C. to 80° C., and 60° C. to 80° C.

In addition, in the humidification step (ST20), it is preferable that the humidification treatment is performed in an atmosphere in which a CO₂ concentration is 200 ppm or less. In addition, in the humidification treatment, in a case where the CO₂ concentration is equal to or less than the above-described upper limit value, the amount of the lithium carbonate in the CAM is not likely to increase.

From such a viewpoint, the CO₂ concentration in the humidification treatment is more preferably 100 ppm or less and particularly preferably 50 ppm or less.

In the humidification step (ST20), it is preferable to perform the humidification treatment in an atmosphere having a temperature of 80° C. to 400° C.

In the humidification treatment, in a case where the temperature is equal to or higher than the above-described lower limit value, moisture in contact with the CAM is appropriately volatilized, and thus a problem of the moisture being lumped during the execution of the humidification step is less likely to occur. In addition, in a case where the temperature is equal to or lower than the above-described upper limit value, it is possible to prevent the CAM from being re-calcined and the crystal grain diameter from being excessively increased. As a result, it is possible to prevent an increase in diffusion resistance of lithium ions in the crystal structure and to suppress a deterioration in rate performance.

From such a viewpoint, a temperature of the humidification treatment is more preferably 90° C. or higher, particularly preferably 100° C. or higher, and still more preferably 300° C. or lower. Examples of the range of the temperature of the humidification treatment include 80° C. to 300° C., 90° C. to 400° C., 100° C. to 400° C., and 100° C. to 300° C.

In the humidification step (ST20), a treatment time is preferably 0.1 to 5 hours. In the humidification treatment, in a case where the treatment time is equal to or longer than the above-described lower limit value, a sufficient humidification treatment can be performed. In addition, in a case where the treatment time is equal to or shorter than the above-described upper limit value, the amount of moisture in contact with the CAM is small, and the lithium hydroxide or the lithium carbonate, generated by extracting Li from the inside of the CAM, is hardly generated as a residue in a large amount, and thus the generation of gas in the lithium secondary battery can be sufficiently suppressed.

From such a viewpoint, the treatment time of the humidification treatment is more preferably 0.2 to 2.5 hours and particularly preferably 0.3 to 2 hours.

[B-3] Drying step (ST30)

In the drying step (ST30), the CAM is produced by subjecting the calcined powder which has been subjected to the humidification treatment in the humidification step (ST20) to a drying treatment.

In the drying step (ST30), it is preferable to perform the drying treatment in an atmosphere having a temperature of 100° C. to 400° C. The temperature of the drying treatment is preferably equal to or higher than the lower limit value of the above-described range in order to prevent a decrease in charging capacity of the lithium secondary battery due to the moisture remaining in the CAM before the drying treatment. Therefore, the lower limit value of the temperature of the drying treatment is more preferably 110° C. and particularly preferably 120° C. In addition, the temperature of the drying treatment is preferably equal to or lower than the upper limit value of the above-described range in order to prevent the rate performance from deteriorating due to the re-calcining of the CAM. Therefore, the upper limit value of the temperature of the drying treatment is more preferably 350° C. and particularly preferably 300° C. Examples of the temperature range of the drying treatment include 100° C. to 350° C., 110° C. to 350° C., and 120° C. to 300° C.

The drying is carried out by, for example, decompression drying, vacuum drying, blowing, heating, or a combination thereof. The decompression drying and the vacuum drying are carried out, for example, at 100° C. to 200° C. under a pressure of 0.3 atm or less. The drying by blowing air is carried out using, for example, a hot air dryer.

In the drying step (ST30), a treatment time is preferably 0.1 hours or longer. In a case where the treatment time is equal to or longer than the above-described lower limit value in the drying treatment, the drying treatment can be sufficiently performed.

From such a viewpoint, the treatment time of the drying treatment is more preferably 0.5 hours or longer and particularly preferably 1.0 hour or longer.

In addition, in the drying step (ST30), it is preferable that the drying treatment is performed in an atmosphere in which a CO₂ concentration is 200 ppm or less. In addition, in the drying treatment, in a case where the CO₂ concentration is equal to or less than the above-described upper limit value, the increase in lithium carbonate in the CAM can be suppressed, and thus the generation of gas in the lithium secondary battery can be sufficiently suppressed.

From such a viewpoint, the CO₂ concentration in the drying treatment is more preferably 100 ppm or less and particularly preferably 50 ppm or less.

The CAM can be produced by adjusting the treatment conditions in the humidification step (ST20) and the drying step (ST30).

### [C] Lithium Secondary Battery

An example of a positive electrode for lithium secondary battery, which contains the CAM according to the present embodiment, and a lithium secondary battery including the positive electrode for lithium secondary battery will be described. Hereinafter, the positive electrode for lithium secondary battery will be referred to as a positive electrode in some cases.

An example of the lithium secondary battery which is suitable in a case where the LiMO produced by the production method according to the present embodiment is used as the CAM has a positive electrode, an anode, a separator interposed between the positive electrode and the anode, and an electrolytic solution disposed between the positive electrode and the anode.

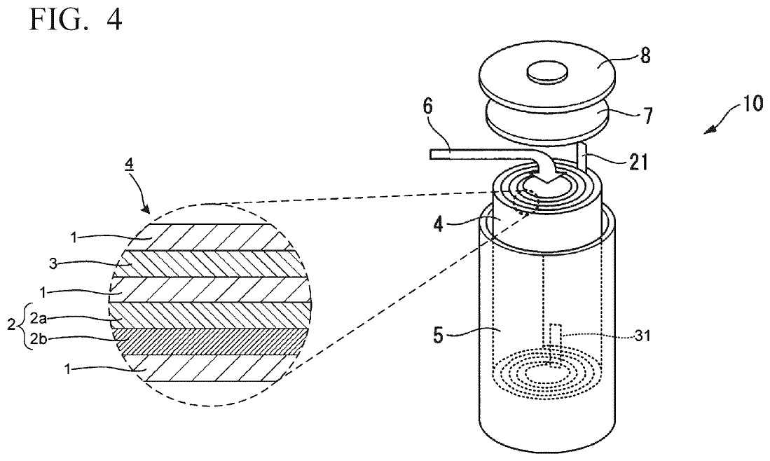

FIG. 4 is a schematic view showing an example of the lithium secondary battery. For example, a cylindrical lithium secondary battery 10 is manufactured as described below.

First, as shown in a partially enlarged view of FIG. 4, a pair of separators 1 having a strip shape, a positive electrode 2 having a strip shape, in which a positive electrode lead 21 is installed at one end, and an anode 3 having a strip shape, in which an anode lead 31 is installed at one end, are provided. The laminate is wound in which the separator 1, the positive electrode 2, the separator 1, and the anode 3 are laminated in this order, thereby producing an electrode group 4.

The positive electrode 2 includes, for example, a positive electrode active material layer 2a containing the CAM and a positive electrode current collector 2b having the positive electrode active material layer 2a formed on one surface thereof. The positive electrode 2 can be produced by first preparing a positive electrode material mixture containing the CAM, a conductive material, and a binder, and supporting the positive electrode material mixture on one surface of the positive electrode current collector 2b to form a positive electrode active material layer 2a.

As an example of the anode 3, an electrode in which an anode material mixture containing an anode active material (not shown) is supported on an anode current collector, and an electrode consisting of an anode active material alone are exemplary examples, and the anode 3 can be produced in a manner similar to that for the positive electrode 2.

Next, the electrode group 4 and an insulator (not shown) are accommodated in a battery can 5, and then a can bottom of the battery can 5 is sealed. The electrode group 4 is impregnated with an electrolytic solution 6 in the battery can 5 to interpose an electrolyte (not shown) between the positive electrode 2 and the anode 3. Thereafter, a top insulator 7 and a sealing body 8 seal the upper part of the battery can 5. In this manner, a lithium secondary battery 10 is completed.

Examples of a shape of the electrode group 4 include a columnar shape in which the cross-sectional shape is a circle, an ellipse, a rectangle, or a rectangle with rounded corners, in a case where the electrode group 4 is cut in a direction perpendicular to a winding axis.

In addition, as the shape of the lithium secondary battery having such an electrode group 4, a shape that is specified by IEC60086, which is a standard specified by the International Electrotechnical Commission (IEC) or by JIS C 8500, can be adopted. Examples thereof include shapes such as a cylindrical shape and a square shape.

Furthermore, the lithium secondary battery is not limited to the above-described winding-type configuration, and may have a lamination-type configuration of a laminated structure in which the positive electrode, the separator, the anode, and the separator are repeatedly stacked. As the lamination-type lithium secondary battery, a so-called coin-type battery, button-type battery, or paper-type (or sheet-type) battery can be exemplary examples.

For the positive electrode, the separator, the anode, and the electrolytic solution constituting the lithium secondary battery, for example, the configurations, materials, and production methods described in [0113] to [0140] of WO2022/113904A1 can be used.

[D] all-Solid-State Lithium Secondary Battery

As an example of the lithium secondary battery including the positive electrode for lithium secondary battery, formed of the CAM according to the present embodiment, an all-solid-state lithium secondary battery will be described.

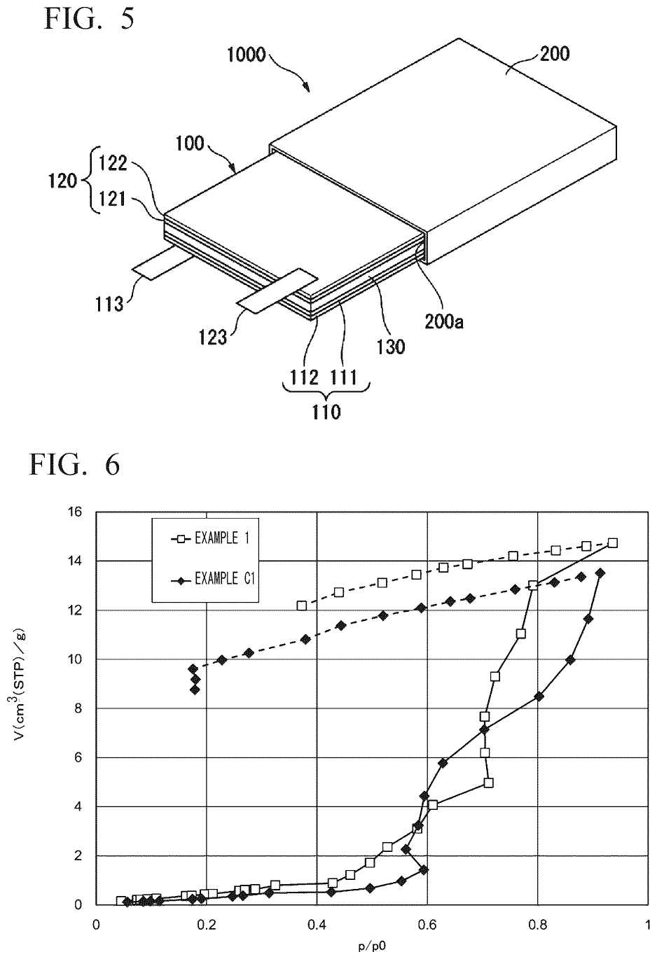

FIG. 5 is a schematic view showing an example of the all-solid-state lithium secondary battery. An all-solid-state lithium secondary battery 1000 shown in FIG. 5 includes a laminate 100 having a positive electrode 110, an anode 120, and a solid electrolyte layer 130, and an exterior body 200 accommodating the laminate 100. The all-solid-state lithium secondary battery 1000 may have a bipolar structure in which the CAM and an anode active material are disposed on both sides of a current collector. Specific examples of the bipolar structure include structures described in JP-A-2004-95400.

The positive electrode 110 has a positive electrode active material layer 111 and a positive electrode current collector 112. The positive electrode active material layer 111 contains the above-described CAM and a solid electrolyte. In addition, the positive electrode active material layer 111 may contain a conductive material and a binder.

The anode 120 has an anode active material layer 121 and the anode current collector 122. The anode active material layer 121 contains an anode active material. In addition, the anode active material layer 121 may contain a solid electrolyte and a conductive material.

The laminate 100 may have an external terminal 113 which is connected to a positive electrode current collector 112 and an external terminal 123 which is connected to an anode current collector 122. In addition, the all-solid-state lithium secondary battery 1000 may have a separator between the positive electrode 110 and the anode 120.

The all-solid-state lithium secondary battery 1000 further includes an insulator (not shown) which insulates the laminate 100 and the exterior body 200 from each other, and a sealant (not shown) which seals an opening portion 200a of the exterior body 200.

The exterior body 200 is a container formed of a highly corrosion-resistant metal material such as aluminum, stainless steel or nickel-plated steel. In addition, the exterior body 200 may be a container obtained by processing a laminate film having at least one surface on which a corrosion resistant process has been carried out into a bag shape.

Examples of a shape of the all-solid-state lithium secondary battery 1000 include a coin type, a button type, a paper type (or a sheet type), a cylindrical type, a square type, and a laminate type (pouch type).

The all-solid-state lithium secondary battery 1000 has a form in which one laminate 100 is provided, but the present invention is not limited thereto. The all-solid-state lithium secondary battery 1000 may have a configuration in which the laminate 100 is used as a unit cell and a plurality of unit cells (laminates 100) is sealed inside the exterior body 200.

For the all-solid-state lithium secondary battery, for example, the configurations, materials, and production methods described in [0151] to [0181] of WO2022/113904A1 can be used.

The present invention has the following aspects.

[21]

CAM containing LiMO having a layered structure, which contains a Li element, a Ni element, and the element M, and a lithium compound including lithium hydroxide and lithium carbonate, in which the Va_{0.5}, the Va_{0.9}, and the Vd_{0.5} satisfy a relationship represented by the following (expression A′), the Sm satisfies a relationship represented by the following (expression B′), and the W1 and the W2 satisfy a relationship represented by the following (expression C1′),

0<(Vd_{0.5}−Va_{0.5})/Va_{0.9}≤0.85 (expression A′),

0.2 m²/g≤Sm≤0.8 m²/g (expression B′),

0≤W2/W1≤1.00 (expression C1′).

[22]

The CAM according to [21], in which the LiMO is represented by the (compositional formula I).

[23]

The CAM according to [21] or [22], in which the Sm satisfies a relationship represented by the following expression (B1),

0.2 m²/g≤Sm≤0.7 m²/g (expression B1).

[24]

The CAM according to any one of [21] to [23], in which the W2 satisfies a relationship represented by the following expression (D1′),

0% by mass≤W2≤0.60% by mass (expression D1′).

[25]

The CAM according to any one of [21] to [24], in which the W3 satisfies a relationship represented by the following expression (E1′),

0% by mass or more≤W3≤0.40% by mass (expression E1′).

[26]

The CAM according to any one of [21] to [25], in which the crystal strain is 0.08° or less.

[27]

The CAM according to any one of [21] to [26], in which the average pore diameter is 10 to 100 nm.

[28]

The CAM according to any one of [21] to [27], in which the pore volume is 0.001 to 0.010 cm³/g.

[29]

The CAM according to any one of [21] to [28], in which the D₅₀ is 8 to 20 μm.

[30]

A positive electrode for lithium secondary battery, including the CAM according to any one of [21] to [29].

[31]

A lithium secondary battery including the positive electrode for lithium secondary battery according to [30].

[32]

A method for producing a CAM, including: a preparation step of preparing a calcined powder of a MCC which is a precursor of a LiMO and a lithium compound; a humidification step of subjecting the calcined powder prepared in the preparation step to a humidification treatment; and a drying step of subjecting the calcined powder humidified in the humidification step to a drying treatment to produce the CAM, in which, in the humidification step, the humidification treatment is performed in an atmosphere in which a dew point is 50° C. to 90° C. and a CO₂ concentration is 50 ppm or less.

[33]

The method for producing a CAM according to [32], in which, in the humidification step, the humidification treatment is performed in an atmosphere at a temperature of 90° C. to 400° C.

[34]

The method for producing a CAM according to [32] or [33], in which, in the drying step, the drying treatment is performed in an atmosphere at a temperature of 100° C. to 350° C.

### EXAMPLES

Examples and comparative examples will be described below with reference to Table 1. In Table 1, (Example 1) to (Example 3) correspond to Examples, and (Comparative Example C1) to (Comparative Example C3) correspond to Comparative Examples.

In Table 1, “Humidification treatment condition” is a condition in a case where the humidification treatment is performed in the humidification step (ST20), and “Drying treatment condition” is a condition in a case where the drying treatment is performed in the drying step (ST30).

TABLE 1

| | | | | Exam- | Exam- | Exam- | Exam- | Exam- | Exam- |
|---|---|---|---|---|---|---|---|---|---|
| | | | | ple 1 | ple 2 | ple 3 | ple C1 | ple C2 | ple C3 |
| Humidification | Treatment temperature | | ° C. | 300 | 300 | 300 | — | — | 300 |
| treatment | Treatment time | | hr | 1 | 0.3 | 2 | | | 1 |
| condition | Dew point | | ° C. | 60 | 60 | 60 | — | — | 60 |
| | CO₂ concentration | | ppm | <1 | <1 | <1 | — | — | 400 |
| Drying | Treatment temperature | | ° C. | 300 | 300 | 300 | — | 120 | 300 |
| treatment | Treatment time | | hr | 1 | 1 | 1 | | 10 | 1 |
| condition | CO₂ concentration | | ppm | <1 | <1 | <1 | — | — | 400 |
| Evaluation | (Requirement 1) | Water retention | — | 0.77 | 0.81 | 0.78 | 0.95 | 0.30 | 0.80 |
| of physical | | parameter | | | | | | | |
| properties | | (Vd_{0.5} − | | | | | | | |
| | | Va_{0.5})/Va_{0.9} | | | | | | | |
| | (Requirement 2) | BET specific | m²/g | 0.3 | 0.2 | 0.3 | 0.2 | 0.9 | 0.2 |
| | | surface area Sm | | | | | | | |
| | (Requirement 3) | W2/W1 | — | 0.42 | 0.42 | 0.42 | 0.39 | 1.33 | 1.44 |
| | — | Mass | % by | 0.98 | 1.05 | 1.04 | 1.16 | 0.06 | 0.69 |
| | | proportion W1 | mass | | | | | | |
| | | of LiOH | | | | | | | |
| | | Mass | % by | 0.41 | 0.44 | 0.44 | 0.45 | 0.08 | 0.99 |
| | | proportion W2 | mass | | | | | | |
| | | of Li₂CO₃ | | | | | | | |
| | | Amount W3 of | % by | 0.36 | 0.39 | 0.38 | 0.42 | 0.03 | 0.38 |
| | | eluted lithium | mass | | | | | | |
| | Li[Liₘ(Ni_{(1-x-y)}CoₓM1_{y})₁₋ₘ]O₂ | x | — | 0.09 | 0.09 | 0.09 | 0.09 | 0.09 | 0.09 |
| | | y | | 0.03 | 0.03 | 0.03 | 0.03 | 0.03 | 0.03 |
| | | m | | 0.06 | 0.07 | 0.06 | 0.06 | 0.01 | 0.06 |
| | Others | Crystal strain | ° | 0.07 | 0.07 | 0.07 | 0.08 | 0.05 | 0.07 |
| | | Pore volume | cm³/g | 0.0013 | 0.0012 | 0.0012 | 0.0012 | 0.0043 | 0.0012 |
| | | Average pore | nm | 19.0 | 20.1 | 15.7 | 21.3 | 20.0 | 19.5 |
| | | diameter | | | | | | | |
| | | D50 | μm | 13.7 | 13.8 | 13.8 | 13.4 | 13.4 | 13.9 |

| | | | | | | | | |
|---|---|---|---|---|---|---|---|---|
| Evaluation | Float electrical quantity | mAh/g | 5.3 | 5.5 | 5.4 | 6.1 | 5.3 | 7.3 |
| of battery | Rate performance [(1 C/0.2 C) | % | 97.0 | 96.6 | 97.2 | 97.4 | 91.8 | 96.8 |
| | discharge capacity] | | | | | | | |

### [1] Production of Sample of CAM

A procedure for producing a sample of the CAM according to each example will be described in order.

### Example 1

In (Example 1), first, a powder of a nickel-cobalt-aluminum metal composite oxide was produced as MCC which was a precursor of LiMO.

First, water was put into a reaction vessel equipped with a stirrer and an overflow pipe, and then a sodium hydroxide aqueous solution was added to the reaction vessel. At this time, a liquid temperature of the solution in the reaction vessel was maintained at 50° C. A mixed solution was prepared by mixing a nickel sulfate aqueous solution, a cobalt sulfate aqueous solution, and an aluminum sulfate aqueous solution at a ratio at which a mole ratio of Ni, Co, and Al was 88:9:3. In addition, an ammonium sulfate aqueous solution was prepared as a complexing agent.

The above-described mixed solution and the ammonium sulfate aqueous solution were continuously added to the reaction vessel while stirring. At this time, a sodium hydroxide aqueous solution was added dropwise thereto so that a pH of the mixed solution in the reaction vessel was 11.6 (liquid temperature at the time of measurement: 40° C.). As a result, reaction precipitates were obtained.

Thereafter, the reaction precipitates were washed with water and then subjected to a dewatering treatment using a centrifuge to isolate the reaction precipitate, and the reaction precipitate was dried at 105° C. to obtain a metal composite hydroxide.

The metal composite hydroxide was heated in an atmospheric air at a temperature of 650° C. for 5 hours, and then cooled to room temperature. In this manner, an MCC which was a nickel-cobalt-aluminum metal composite oxide was obtained.

Next, a powder of lithium hydroxide monohydrate prepared as a lithium compound and the MCC were mixed with each other. Here, the mixing was carried out such that a value obtained by dividing the molar amount [Li] of the Li element by a value obtained by adding the molar amount [Ni] of the Ni element, the molar amount [Co] of the Co element, and the molar amount [Al] of the Al element was 1.06 (that is, [Li]/([Ni]+[Co]+[Al])=1.06).

Next, a mixture of the MCC and the lithium hydroxide monohydrate was calcined. The calcining was carried out for 5 hours under a condition of a temperature of 740° C. in an oxygen atmosphere.

Next, the calcined product obtained by the above-described calcining was crushed with a stone mill type crusher to obtain a calcined powder (preparation step (ST10) of FIG. 3).

Next, the above-described calcined powder was subjected to a humidification treatment (humidification step (ST20) in FIG. 3).

The humidification treatment was carried out under the humidification treatment condition shown in Table 1. Specifically, 150 g of the calcined powder was subjected to a humidification treatment under a condition that the treatment temperature was 300° C. and the treatment time was 1 hour. In this case, air adjusted to have a dew point of 60° C. and a CO₂ concentration of less than 1 ppm was allowed to flow.

Next, the calcined powder subjected to the humidification treatment was subjected to a drying treatment (drying step (ST30) in FIG. 3).

The drying treatment was carried out under the drying treatment condition shown in Table 1. Specifically, the drying treatment was carried out under conditions of a treatment temperature of 300° C. and a treatment time of 1 hour. In this case, air adjusted to have a dew point of −30° C. or lower and a CO₂ concentration of less than 1 ppm was allowed to flow. In this manner, the sample of the CAM in (Example 1) was completed.

### (Example 2) and (Example 3)

In (Example 2) and (Example 3), the humidification treatment was performed under conditions that the treatment time of the humidification treatment condition was different from that in (Example 1), as shown in Table 1. Specifically, the treatment time of (Example 2) was 0.3 hours, and the treatment time of (Example 3) was 2 hours. Except for this point, in (Example 2) and (Example 3), the sample of the CAM was completed as in the case of (Example 1).

### Example C1

In (Example C1), the humidification treatment and the drying treatment were not carried out, unlike (Example 1) and the like as shown in Table 1. That is, in (Example C1), the calcined powder obtained before the execution of the humidification treatment in (Example 1) was used as the sample of the CAM.

### Example C2

In (Example C2), as shown in Table 1, the humidification treatment was not carried out in the same manner as in (Example C1). In (Example C2), a water washing treatment was carried out on the calcined powder obtained before the execution of the humidification treatment in (Example 1), and the drying treatment was carried out after the water washing treatment.

In (Example C2), the water washing treatment and the drying treatment were carried out under the following conditions.

### [Water Washing Treatment Condition]

The water washing treatment was carried out by dispersing 50 g of the calcined powder in 50 g of pure water and stirring for 20 minutes; the calcined powder after the washing with water was collected by decompression filtration.

### [Drying Treatment Condition]

The drying treatment was carried out by drying the calcined powder after the washing with water under reduced pressure under conditions of 120° C. for 10 hours.

As described above, in (Example C2), the sample of the CAM was completed in the same manner as in (Example 1), except that the humidification treatment was not carried out, and the water washing treatment and the drying treatment were sequentially carried out.

### Example C3

In (Example C3), as shown in Table 1, the humidification treatment and the drying treatment were carried out under conditions different from those of (Example 1).

Specifically, in (Example C3), the humidification treatment was carried out in the same manner as in (Example 1), except that the atmosphere gas was changed to air having a CO₂ concentration of 400 ppm as shown in the humidification treatment condition in Table 1.

In (Example C3), the drying treatment was carried out in the same manner as in (Example 1), except that the atmosphere gas was changed to air having a CO₂ concentration of 400 ppm as shown in the drying treatment condition in Table 1.

As described above, in (Example C3), the sample of the CAM was completed in the same manner as in (Example 1), except that the humidification treatment condition was different from that in (Example 1).

### [2] Evaluation of Physical Properties

Regarding the samples of the CAM, produced for each example as described above, evaluations of physical properties corresponding to the above-described (requirement 1) to (requirement 3) was carried out as shown in Table 1.

[2-1] Water Retention Parameter [=(Vd_{0.5}−Va_{0.5})/Va_{0.9}]

Specifically, as shown in Table 1, as the evaluation of physical properties corresponding to the (requirement 1), a water retention parameter [(Vd_{0.5}−Va_{0.5})/Va_{0.9}] was obtained for each example.

The water retention parameter [=(Vd_{0.5}−Va_{0.5})/Va_{0.9}] was obtained by measuring the water-vapor adsorption amount by the water-vapor adsorption method for the sample of each example and obtaining the adsorption isotherm and the desorption isotherm from the result, as described in the section of (Measurement of water retention parameter) above.

FIG. 6 is a diagram showing the adsorption isotherm and the desorption isotherm used in a case of obtaining the water retention parameter in relation to (Example 1) and (Example C1). In FIG. 6, a horizontal axis represents the relative pressure p/p₀, and the vertical axis represents the water-vapor adsorption amount V (cm³ (STP)/g). In FIG. 6, as in FIG. 2, the adsorption isotherm is indicated by a solid line, and the desorption isotherm is indicated by a broken line.

In (Example 1) and (Example C1), the water retention parameter was determined using the adsorption isotherm and the desorption isotherm shown in FIG. 6. Although not shown in the drawing, in the other examples, the water retention parameters were determined using the adsorption isotherm and the desorption isotherm in the same manner.

### [2-2] BET Specific Surface Area Sm

As shown in Table 1, the BET specific surface area Sm was obtained for each example as the evaluation of physical properties corresponding to the above-described (requirement 2).

The measurement of Sm was carried out by the nitrogen adsorption method using a nitrogen gas as an adsorbed gas, as described in the section of (Measurement of Sm) above.

### [2-3] W2/W1 and W3

As shown in Table 1, as the evaluation of physical properties corresponding to the above-described (requirement 3), the value (W2/WT) obtained by dividing the mass proportion W2 of lithium carbonate by the mass proportion W1 of lithium hydroxide and the W3 were obtained for each example.

The measurements of W1, W2, and W3 were carried out by the method described in the section of (Neutralization titration method) above.

In Table 1, the results of W1 and W2 are shown together. In addition, the result of W3 is also shown in Table 1. In addition, the values of x, y, and m in the (compositional formula I) (═Li[Liₘ(Ni_{(1-x-y)}CoₓM1_{y})₁₋ₘ]O₂) of the LiMO are shown in Table 1. In addition, the results of obtaining the crystal strain, the average pore diameter, the pore volume, and the D₅₀ of the CAM are shown. The composition and physical properties were measured by the methods described in the sections of (Measurement of composition) and [A-3-4] above. In addition, the LiMO in the CAM obtained in (Example 1) to (Example 3) and (Example C1) to (Example C3) had a layered structure as a result of the powder X-ray diffraction measurement.

### [3] Evaluation of Battery

As described above, battery evaluation was carried out for the sample of the CAM produced in each example as shown in Table 1.

In a case of carrying out the battery evaluation, a positive electrode for lithium secondary battery was prepared from the sample of the CAM of each example, and then a lithium secondary battery was produced using the produced positive electrode for lithium secondary battery. Thereafter, for the produced lithium secondary battery, a float electric quantity and rate performance were measured as shown in Table 1.

### [3-1] Production of Positive Electrode for Lithium Secondary Battery

In a case of producing the positive electrode for lithium secondary battery, first, a paste-like positive electrode mixture was prepared. The positive electrode mixture was prepared by kneading a mixture of the CAM produced in each example, a conductive material, and a binder. Here, acetylene black was used as the conductive material, and PVdF was used as the binder. Each material was mixed at the following ratio. During the preparation of the positive electrode material mixture, N-methyl-2-pyrrolidone was used as an organic solvent.
CAM: 92 parts by mass
Conductive material: 5 parts by mass
Binder: 3 parts by mass

The paste-like positive electrode mixture prepared as described above was applied onto a collector (an aluminum foil having a thickness of 40 μm). Thereafter, the current collector coated with the positive electrode mixture was subjected to vacuum drying for 8 hours in an atmosphere at a temperature of 150° C. to complete the positive electrode for lithium secondary battery. Here, an electrode area of the positive electrode for lithium secondary battery was 1.65 cm².

### [3-2] Production of Lithium Secondary Battery

In a case of producing the lithium secondary battery, first, the positive electrode for lithium secondary battery prepared as described above was placed on an upper surface of a lower lid of a part for a coin type battery R2032 (manufactured by HOUSEN Co., Ltd.). In the installation on the lower lid, an aluminum foil surface of the positive electrode for lithium secondary battery was directed downward. A laminated film separator was installed on the upper surface of the lower lid on which the positive electrode for lithium secondary battery was installed. Here, as the laminated film separator, a laminated film separator having a thickness of 16 μm and including a heat-resistant porous layer laminated on a polyethylene porous film was used.

Next, 300 μl of an electrolytic solution was injected into the inside of the above-described part. Here, as the electrolytic solution, a solution in which LiPF₆ was dissolved in a mixed solution obtained by mixing the respective substances at the following ratio was used. The electrolytic solution was prepared such that a concentration of LiPF₆ was 1 mol/l.
Ethylene carbonate: 30 parts by volume
Dimethyl carbonate: 35 parts by volume
Ethyl methyl carbonate: 35 parts by volume

Next, an anode was installed on the upper side of the separator. Here, metallic lithium was used as the anode. The upper lid was installed through a gasket, and the upper lid was crimped using a crimping machine. As a result, a coin type half cell R2032 was produced as the lithium secondary battery.

### [3-3] Float Test

As an index for evaluating an amount of gas generated in the battery, a float electric quantity was measured. The float electrical quantity is an electrical quantity observed in a case where an irreversible reaction occurs with the electrolytic solution at the particle interface. As the value of the float electrical quantity to be observed is larger, the amount of gas generated is larger.

Specifically, the float electrical quantity was measured under the following conditions.
Test temperature: 60° C.
Charging maximum voltage: 4.3 V, charging current: 0.2 CA
Constant voltage retention time: 60 hours

In the float test, the integrated electric quantity during the constant voltage retention time after transition to the constant voltage mode of 4.3 V was calculated as the float electric quantity (mAh/g). In the evaluation of the float test, a case where the float electricity quantity was 6.0 mAh/g or less was determined to that the float electricity quantity was small.

### [3-4] Rate Performance [(1 C/0.2 C) Discharge Capacity]

The rate performance is a proportion (%) of a discharge capacity at a charging and discharging rate of 1 C to a discharge capacity at a charging and discharging rate of 0.2 C. In the evaluation of the rate performance, it was determined that the rate performance was high in a case where the rate performance was 95% or more.

Specifically, the rate performance was measured under the following conditions.

### (Measurement Conditions for Rate Performance)

### (0.2 C Discharge Capacity)

Test temperature: 25° C.
Charging maximum voltage 4.3 V, charging current 0.2 CA; constant current constant voltage charging, ended at 0.05 CA current value
Discharging minimum voltage: 2.5 V; discharging current density: 0.2 CA; constant current discharging

### (1 C Discharge Capacity)

Treatment temperature: 25° C.
Charging maximum voltage 4.3 V, charging current 1 CA; constant current constant voltage charging, ended at 0.05 CA current value
Discharging minimum voltage: 2.5 V; discharging current density: 1 CA; constant current discharging

### [4] Summary

The “Evaluation of physical properties” and the “Evaluation of battery” of each example will be described.

### [4-1] Regarding Results of (Example 1) to (Example 3)

(Example 1) to (Example 3) all satisfied the relationship of the above-described (expression A) defined as the (requirement 1), the above-described (expression B) defined as the (requirement 2), and the above-described (expression C) defined as the (requirement 3), as shown in the column of “Evaluation of physical properties” in Table 1.

Therefore, in (Example 1) to (Example 3), since the relationship between the (expression A) defined as the (requirement 1) and the (expression C) was satisfied as shown in the column of “Evaluation of battery” in Table 1, the value of the float electric quantity was small; and since the relationship of the (expression B) defined as the (requirement 2) was satisfied, the value of the rate performance was high.

### [4-2] Regarding Results of (Example C1)

On the other hand, in (Example C1), the relationship of the (expression A) defined as the (requirement 1) was not satisfied as shown in the column of “Evaluation of physical properties” in Table 1. The value calculated by the (expression A) is the water retention parameter, and the water retention parameter of (Example C1) was higher than the water retention parameters of (Example 1) to (Example 3). Therefore, in (Example C1), since water was more easily held than in (Example 1) to (Example 3), the number of activation sites at which the side reaction easily occurred in the lithium secondary battery was larger than in (Example 1) to (Example 3). As a result, in (Example C1), the float electric quantity was large as shown in the column of “Evaluation of battery” in Table 1.

In (Example C1), the humidification treatment and the drying treatment were not carried out unlike (Example 1) to (Example 3). The execution of the humidification treatment deactivated the activation site at which the side reaction easily occurred in the lithium secondary battery by contact with water. From this, it is considered that, in a case where the humidification treatment was not carried out as in (Example C1), the activation site at which the side reaction easily occurred in the lithium secondary battery could not be deactivated, and thus the relationship of the (expression A) was not satisfied.

### [4-3] Regarding Results of (Example C2)

In (Example C2), the relationship of the (expression B) defined as the (requirement 2) was not satisfied as can be seen from the results shown in the column of “Evaluation of physical properties” in Table 1. In the (expression B), Sm is defined, and Sm of (Example C2) was higher than Sm of (Example 1) to (Example 3). Therefore, in (Example C2), the side reaction occurring on the surface of the CAM in the charging and discharging of the lithium secondary battery could not be suppressed as compared with (Example 1) to (Example 3). As a result, in (Example C2), the value of the rate performance was low as shown in the column of “Evaluation of battery” in Table 1.

In (Example C2), the water washing treatment was carried out instead of the humidification treatment unlike (Example 1) to (Example 3). As in the humidification treatment, the water washing treatment deactivated the activation site at which the side reaction easily occurred in the lithium secondary battery by contact with water. However, in a case where the water washing treatment was carried out, the lithium compound remaining at the grain boundary of the LiMO and filling the pores was excessively removed. From this, in a case where the water washing treatment was carried out as in (Example C2), it is considered that, since it is difficult to satisfy the relationship of the (expression B), a large number of side reactions occurred on the CAM surface in the charging and discharging cycle of the lithium secondary battery, and thus the value of the rate performance was low.

### [4-4] Regarding Results of (Example C3)

In (Example C3), the relationship of the (expression C) defined as the (requirement 3) was not satisfied as can be seen from the results shown in the column of “Evaluation of physical properties” in Table 1. The (expression C) is defined for the W2/W1, and the value of W2/W1 in (Example C3) was larger than that in (Example 1) to (Example 3). Therefore, in (Example C3), the generation of gas in the lithium secondary battery could not be suppressed as compared with (Example 1) to (Example 3). As a result, in (Example C3), the float electric quantity was large as shown in the column of “Evaluation of battery” in Table 1.

In (Example C3), the humidification treatment was carried out in the same manner as in (Example 1) to (Example 3). However, in (Example 1) to (Example 3), the humidification treatment was carried out in an atmosphere in which the CO₂ concentration was 200 ppm or less (less than 1 ppm), whereas in (Example C3), the humidification treatment was carried out in an atmosphere in which the CO₂ concentration was more than 200 ppm (400 ppm). As a result, in (Example C3), it is considered that the W2 was particularly large among the lithium compounds remaining on the surface of the CAM, and thus the relationship of the (expression C) was not satisfied.

### INDUSTRIAL APPLICABILITY

According to the present invention, it is possible to provide a positive electrode active material for lithium secondary battery, a positive electrode for lithium secondary battery, a lithium secondary battery, and a method of producing a positive electrode active material for lithium secondary battery, which can easily realize a lithium secondary battery having excellent rate performance while suppressing generation of gas.

### REFERENCE SIGNS LIST

1: Separator
2: Positive electrode
3: Anode
4: Electrode group
5: Battery can
6: Electrolytic solution
7: Top insulator
8: Sealing body
10: Lithium secondary battery
21: Positive electrode lead
31: Anode lead
51: Lithium metal composite oxide
61: Lithium compound
71: Activation site
100: Laminate
110: Positive electrode
111: Positive electrode active material layer for lithium secondary battery
112: Positive electrode current collector
113: External terminal
120: Anode
121: Anode active material layer
122: Anode current collector
123: External terminal
130: Solid electrolyte layer
200: Exterior body
200a: Opening portion
1000: All-solid-state lithium secondary battery

1. A positive electrode active material for lithium secondary battery, comprising:
a lithium metal composite oxide having a layered structure, which contains a Li element, a Ni element, and an element M; and
a lithium compound including lithium hydroxide and lithium carbonate,
wherein the element M is at least one element selected from the group consisting of Co, Mn, Fe, Cu, Ti, Mg, Ca, Ba, Al, Zn, Sn, Zr, Nb, B, Si, S, and P,
in a case where, with regard to a water-vapor pressure p and a saturated vapor pressure p₀, in an adsorption isotherm of a water-vapor adsorption method, a water-vapor adsorption amount at a relative pressure p/p₀ of 0.5 is denoted as Va_{0.5} and a water-vapor adsorption amount at a relative pressure p/p₀ of 0.9 is denoted as Va_{0.9}, and in a desorption isotherm of the water-vapor adsorption method, a water-vapor adsorption amount at a relative pressure p/p₀ of 0.5 is denoted as Vd_{0.5}, a relationship represented by the following (expression A) is satisfied,
a BET specific surface area Sm measured by a nitrogen adsorption method satisfies a relationship represented by the following (expression B), and
a mass proportion W1 of the lithium hydroxide and a mass proportion W2 of the lithium carbonate satisfy a relationship represented by the following (expression C),
(Vd_{0.5}−Va_{0.5})/Va_{0.9}≤0.90 (expression A),
Sm≤0.8 m²/g (expression B),
W2/W1≤1.40 (expression C).

2. The positive electrode active material for lithium secondary battery according to claim 1,
wherein the lithium metal composite oxide is represented by the following (compositional formula I),
Li[Liₘ(Ni_{(1-x-y)}CoₓM1_{y})₁₋ₘ]O₂ (compositional formula I),
(in the (compositional formula I), M1 is at least one element selected from the group consisting of Mn, Fe, Cu, Ti, Mg, Ca, Ba, Al, Zn, Nb, Sn, Zr, B, Si, S, and P, and m, x, and y satisfy relationships represented by −0.1≤m≤0.2, 0≤x≤0.5, 0<y≤0.7, and x+y<1).

3. The positive electrode active material for lithium secondary battery according to claim 1,
wherein the Sm satisfies a relationship represented by the following expression (B1),
0.2 m²/g≤Sm≤0.7 m²/g (expression B1).

4. The positive electrode active material for lithium secondary battery according to claim 1,
wherein the W2 satisfies a relationship represented by the following expression (D),
W2≤0.70% by mass (expression D).

5. The positive electrode active material for lithium secondary battery according to claim 1,
wherein an amount W3 of eluted lithium of the positive electrode active material for lithium secondary battery, which is measured by a neutralization titration method, satisfies a relationship represented by the following expression (E),
W3≤0.50% by mass (expression E).

6. The positive electrode active material for lithium secondary battery according to claim 1,
wherein, in a diffraction pattern of powder X-ray diffraction measured with a CuKα ray, a crystal strain calculated from the diffraction pattern in which a diffraction angle 2θ is included in a range of 10° or more and 90° or less is 0.10° or less.

7. The positive electrode active material for lithium secondary battery according to claim 1,
wherein an average pore diameter measured by the nitrogen adsorption method is 150 nm or less.

8. The positive electrode active material for lithium secondary battery according to claim 1,
wherein a pore volume measured by the nitrogen adsorption method is 0.0005 cm³/g or more and 0.0150 cm³/g or less.

9. The positive electrode active material for lithium secondary battery according to claim 1,
wherein a 50% cumulative volume particle size D₅₀ is 3 μm or more and 30 μm or less.

10. A positive electrode for lithium secondary battery, comprising:
the positive electrode active material for lithium secondary battery according to claim 1.

11. A lithium secondary battery comprising:
the positive electrode for lithium secondary battery according to claim 10.

12. A method for producing a positive electrode active material for lithium secondary battery, comprising:
a preparation step of preparing a calcined powder of a metal composite compound which is a precursor of a lithium metal composite oxide and a lithium compound;
a humidification step of subjecting the calcined powder prepared in the preparation step to a humidification treatment; and
a drying step of subjecting the calcined powder humidified in the humidification step to a drying treatment to produce the positive electrode active material for lithium secondary battery,
wherein, in the humidification step, the humidification treatment is performed in an atmosphere in which a dew point is 50° C. or higher and 90° C. or lower and a CO₂ concentration is 200 ppm or less.

13. The method for producing a positive electrode active material for lithium secondary battery according to claim 12,
wherein, in the humidification step, the humidification treatment is performed in an atmosphere at a temperature of 80° C. or higher and 400° C. or lower.

14. The method for producing a positive electrode active material for lithium secondary battery according to claim 12,
wherein, in the drying step, the drying treatment is performed in an atmosphere at a temperature of 100° C. or higher and 400° C. or lower.
